(19) United States
(12) Patent Application Publication
(10) Pub. No.: US 2026/0339894 A1
(43) Pub. Date: Oct. 29, 2026

(54) SYSTEM AND METHOD FOR FILE CONTENT DETECTION

(71) Applicant: Board of Regents, The University of Texas System, Austin, TX (US)

(72) Inventors: Kim-Kwang Choo, San Antonio, TX (US); Adam L. Hooker, San Antonio, TX (US); Wenjian Huang, San Antonio, TX (US); Nishant Vishwamitra, San Antonio, TX (US)

(21) Appl. No.: 19/641,479

(22) Filed: Apr. 7, 2026

Related U.S. Application Data
(60) Provisional application No. 63/784,946, filed on Apr. 7, 2025.

(51) Int. Cl. G06F 16/17

(52) U.S. Cl. CPC G06F 16/17

(57) ABSTRACT

A system and method for identifying file content in encrypted and/or compressed files without decryption or decompression are disclosed. Byte frequency distributions (BFDs) are generated for files within a directory on a data storage device. A machine learning model, preferably an ensemble bagged tree (EBT) classifier, examines the BFDs to predict file types and associated uncertainty values derived from entropy of ensemble predictions. Directories are flagged for further investigation when a tunable percentage (α) of files match targeted content types (such as images or videos) below a defined uncertainty threshold and a tunable percentage (β) of files are encrypted or compressed. Human-in-the-loop feedback, incorporating contextual data such as suspect background, enables parameter tuning. The invention is particularly useful for law enforcement triage of electronic devices while respecting privacy constraints.

### RELATED APPLICATIONS

This application claims the benefit of priority under 35 U.S.C. § 119(e) to U.S. Provisional Patent Application No. 63/784,946, filed Apr. 7, 2025, the entire contents of which are hereby incorporated by reference.

### FIELD

The present disclosure relates generally to the field of data encryption, and in particular to a system and method for evaluating content type of encrypted and compressed files in a file directory.

### BACKGROUND

Encryption and compression software are a double-edged sword; they can be (ab)used by malevolent entities to shield illegal activities from the detection of law enforcement agencies (LEAs), such as file content that includes child sexual abuse materials (CSAM), non-consensual intimate image (NCII), financial crimes, terrorist materials, espionage, and others. LEAs, such as customs and border protection agencies, are faced with many constraints when facing compressed and/or encrypted files. For example, the number of international travelers (both inbound and outbound) subjected to electronic device searches for illicit materials increased from 8,383 in Fiscal Year 2016 to 14,993 in Fiscal Year 2017 in the first six months. Due to the overwhelming volume, LEAs must be discerning and focused and yet act quickly in their investigations.

### SUMMARY OF INVENTION

The present disclosure relates to a system and method for identifying the content type of files stored in a file directory on a data storage device, particularly when the files are encrypted and/or compressed, without requiring decryption or decompression of the files.

In one aspect, the invention provides a method comprising obtaining access to the files in a file directory, determining a byte frequency distribution (BFD) for each file, examining the BFD of each file using a machine learning model to predict a file type and an associated uncertainty value, and flagging the file directory for further investigation when a predetermined percentage of the files contain targeted file content with uncertainty at or below a threshold and a predetermined percentage of the files are encrypted or compressed files.

In another aspect, the machine learning model comprises an ensemble bagged tree (EBT) model, and the uncertainty value is determined by calculating entropy from the distribution of predictions generated by the plurality of trees in the ensemble.

In yet another aspect, the method includes setting tunable parameter values α (percentage of targeted file content), p (percentage of encrypted or compressed files), and an uncertainty threshold (UT). The directory is flagged when at least α % of the files are classified as targeted file content (such as images or videos) with uncertainty at most UT and at least 0% of the files are encrypted or compressed.

In a further aspect, the invention includes evaluating additional contextual data associated with a flagged directory and revising one or more of the parameters a, 3, or UT based on human-in-the-loop (HiTL) feedback, which may incorporate information such as a suspect's criminal records or background.

In still another aspect, the invention provides a system (tool) comprising an access port for communicating with a data storage device, a processor executing instructions to perform the BFD generation, machine learning examination, and directory flagging operations, and an output device for presenting information regarding flagged directories. The system may be implemented as a portable law-enforcement triage tool with various physical interfaces such as USB ports, memory card readers, or optical disc readers.

In another aspect, the invention is embodied as a non-transitory computer-readable medium storing instructions that, when executed, cause one or more processors to carry out the disclosed method or implement the disclosed system.

The disclosed system and method enable law enforcement agencies and other authorized entities to efficiently triage electronic devices containing potentially large volumes of encrypted or compressed files by identifying directories that are likely to contain targeted content warranting further investigation, while reducing false positives through uncertainty quantification and human oversight. The invention operates without decrypting the files, thereby respecting privacy constraints and facilitating rapid on-site or frontline decision-making.

Definitions—The following terms, as used in this specification and the appended claims, shall have the meanings set forth below, unless the context clearly dictates otherwise. These definitions are provided to clarify the intended scope and usage of certain terms and are not intended to limit the ordinary and customary meaning of any claim term beyond what is expressly stated.

Byte Frequency Distribution (BFD) refers to the statistical distribution or histogram of the frequency of occurrence of each possible byte value (ranging from 0 to 255) within the binary content of a file or data stream. A BFD may be computed for an original file, a compressed file, an encrypted file, or any combination thereof (e.g., compressed-then-encrypted or encrypted-then-compressed).

Targeted file content (or targeted content) means file types of particular interest for detection, such as image files (e.g., JPEG) and video files (e.g., AVI), which are commonly associated with high-priority investigations. Targeted file content is distinguished from other file types such as audio (e.g., MP3), documents (e.g., PDF), or plain text (e.g., TXT).

Encrypted or compressed files include any file that has undergone encryption (for example, using AES-CBC or equivalent), compression (for example, using RAR or equivalent), or both operations in any order. This term also encompasses files that appear encrypted or compressed based on their binary characteristics.

Uncertainty value (or uncertainty) refers to a quantitative measure of the predictive confidence of the machine learning model for a given file. In one embodiment, the uncertainty value is computed as the entropy of the distribution of predictions generated by the individual models (e.g., decision trees) within an ensemble. Lower uncertainty values indicate higher consistency among the ensemble predictions.

Uncertainty threshold (UT) means a tunable value selected by an operator below which a prediction from the machine learning model is considered sufficiently certain to be relied upon for directory-level decision making. Predictions with uncertainty values exceeding the UT may be discarded or treated with lower weight to reduce false positives.

α (alpha) represents a tunable percentage threshold indicating the minimum proportion of files in a directory that must be classified as targeted file content (with uncertainty at or below the UT) for the directory to satisfy one flagging criterion.

β (beta) represents a tunable percentage threshold indicating the minimum proportion of files in a directory that must be classified as encrypted or compressed for the directory to satisfy a second flagging criterion.

Flagging (or flagged file directory) means identifying a directory as warranting further investigation or scrutiny by law enforcement or other authorized personnel. A directory is flagged when it meets the defined criteria involving α, β, and the uncertainty threshold.

Human-in-the-loop (HiTL) feedback refers to the incorporation of human operator input, judgment, or additional contextual information (such as a suspect's criminal records or background) to evaluate flagged directories and to refine or tune the parameters a, 3, and/or UT for improved accuracy or suitability to a specific operational context.

Ensemble bagged tree (EBT) model means a machine learning classifier that constructs multiple decision trees from different subsets or bootstrap samples of the training data and aggregates their predictions (e.g., by majority vote) to produce a final classification and associated uncertainty.

Machine learning model broadly includes any supervised or ensemble-based classifier suitable for processing BFD features, with the EBT model being a preferred embodiment.

Data storage device includes any physical or logical medium capable of storing files, such as hard disk drives (HDDs), solid-state drives (SSDs), USB flash drives, memory cards, optical discs, or portable electronic devices containing file directories.

Access port means any hardware or software interface that enables communication with and retrieval of files from a data storage device, including without limitation USB ports, mini-USB, memory card readers, optical disc readers, or wireless communication interfaces.

Without decrypting or decompressing the files means that the method and system operate solely on the binary content of the files in their encrypted and/or compressed state and do not require or perform decryption keys application or decompression algorithms to recover the original plaintext content.

These definitions apply throughout the specification and claims unless a contrary meaning is clearly indicated. Where a term is used in a claim without a specific definition provided herein, it shall be given its ordinary and customary meaning to a person of ordinary skill in the art at the time of the invention.

### BRIEF DESCRIPTION OF THE DRAWINGS

FIG. 1 is LexisNexis federal case data: A snapshot;

FIG. 2 is EUR-Lex data: A snapshot;

FIG. 3 is a block diagram of an embodiment of the file content detection system and method according to the teachings of the present disclosure;

FIG. 4 is an exemplary algorithm for Directory Level Reconstruction Considering Uncertainty according to the teachings of the present disclosure;

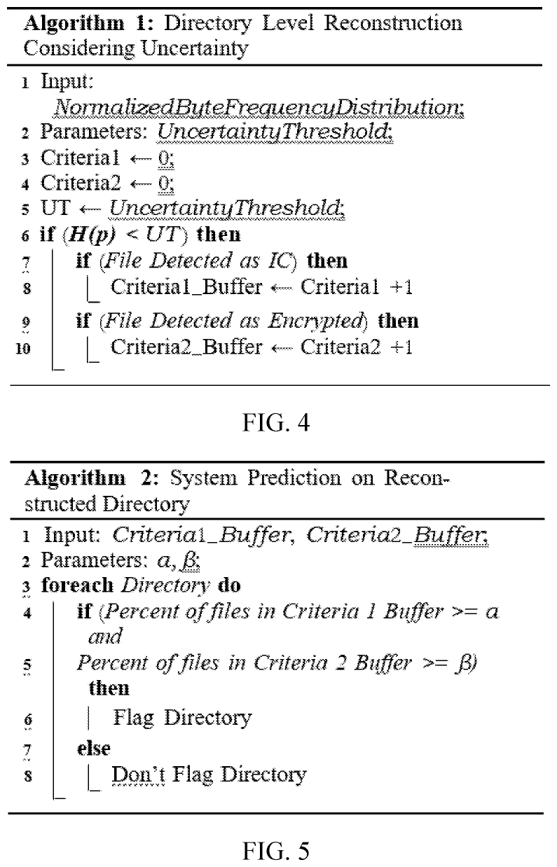

FIG. 5 is an exemplary algorithm for System Prediction on Recon-structed Directory according to the teachings of the present disclosure;

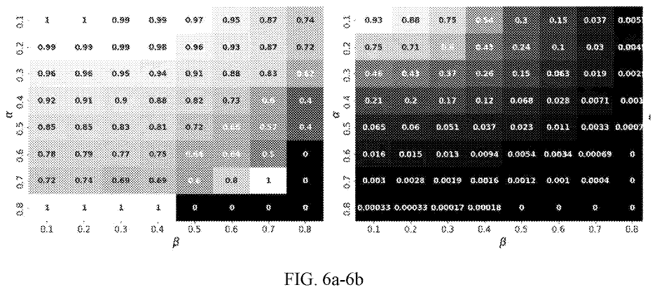

FIGS. 6a-6d are plots that show the effectiveness an embodiment of the present file content detection system and method; and

FIG. 7 is a plot of Relationship of Uncertainty Threshold versus number of False Positives (FP) samples detected in Testing Data according to the teachings of the present disclosure.

### DETAILED DESCRIPTION

The term Byte Frequency Distributions (BFD) refers to the statistical distribution of byte values (0-255) in a given dataset, file, or stream of data. This concept is commonly used in fields such as data compression, cryptography, forensics, and file type identification. The innovative file content detection system and method described herein uses Machine Learning (ML) to aid in the detection of file types in encrypted and/or compressed files for LEA applications based at least in part on the BFD of the files. If LEAs are able to determine with a specific threshold of certainty that a certain file directory under investigation contains encrypted/compressed files with a large volume of a certain file type that is relevant to their investigation (e.g., videos and still images in investigations relating to convicted sex offenders), this information points to a positive indication that the target file directory warrants more focused investigation by the LEAs, such as decryption and decompress selected files in the directory. Thus, the present system and method may serve as a first line of defense to help LEAs quickly pinpoint electronic data storage devices that warrant further careful investigation.

Using ML to detect file types of encrypted or compressed files poses two key challenges. First, whether the data after encryption or compression still has discernible patterns was previously an unexplored area. Since ML algorithms can be only applied if data has discernible patterns, the existence of such patterns in encrypted and compressed data must be first explored. Second, since the detection of file types in encrypted or compressed files is a high-stake decision-making problem involving LEAs where charges based on unreliable data (or evidence) may lead to serious consequences, the certainty of a prediction is needed. Despite the advancement of deep learning techniques in several real-world applications, they only provide a confidence score for a decision without any information regarding the uncertainty in the prediction.

The framework described herein, the encrypted and compressed files are first converted to Byte Frequency Distributions (BFDs), which are used to train an ensemble bagged tree model to detect file types with uncertainty quantification, by analyzing the variance in prediction from sampling the models in the ensemble. The framework is able to successfully flags directories with a precision of 99.0% and provides a recall of 84.0%. The framework thus paves the way for further research in detecting the file types in encrypted or compressed files without the need for decryption and has important implications for LEA applications.

Based on exploratory factors analysis (EFA) on a novel test dataset of original encrypted and/or compressed file types, it is determined that significant discernible patterns can be found in the dataset, with reliable factors based on Cronbach's alpha. A large-scale measurement analysis of state-of-the-art ML approaches found that the ensemble bagged tree outperformed deep learning and transformer models in this task. Therefore, a novel framework to detect the file types in encrypted and/or compressed files is constructed. The framework first converts the encrypted and compressed files into BFDs, which are used to train an ensemble bagged tree model to provide a decision with uncertainty metrics, i.e., the variance in the prediction from several ensemble models. The framework has been show to successfully flag file directories needing further investigation with a precision of 99.0% and provides a recall of 84.0% with optimal parameters. The incorporation of uncertainty quantification effectively mitigated false positives, resulting in a reduction of approximately 70% compared to the minimum number of false positives observed. It is observed that the time complexity scales linearly with the hyper-parameter of the selected model. The most suitable model that best fits the current specific scenario is identified and selected from a comparative evaluation of multiple baseline classification models for the detection of encrypted and compressed file types.

One challenge that had to be overcome is the uncertainty in ML. In real-world scenarios, uncertainty quantification has been used in computer vision (e.g., self-driving cars and object detection), image processing (e.g., image restoration), medical image analysis (e.g., medical image classification and segmentation), natural language processing (e.g., text classification, social media texts and recidivism risk-scoring), bioinformatics, etc. Existing literature suggests that the uncertainty in data could be due to two sources. First, it could be caused by the noise in the data. Second, it could be due to data sparsity or out-of-data distribution. The uncertainty quantification can be classified into two types, namely: generative methods and discriminative methods. In the generative method, out-of-distribution detection is performed. For example, the generative method could be used to reconstruct data from an incomplete or noisy image. On the other hand, in the discriminative method, the input is classified into one or more outputs or no output class. This can be achieved through two methods such as Bayesian methods or non-Bayesian methods.

Bayesian methods involve Bayesian inference that leverages Bayes theorem to update the probability of a hypothesis through soft model selection to find the best model within a hypothesis class. In short, the predictive uncertainty is estimated by learning distribution over the parameters. The two well-known approaches of this method are Backprop and MC dropout. Dropout is used as a method to avoid overfitting in deep learning methods too. This is conducted without compromising on the test accuracy and is simple to implement. The main objective of MC dropout is to minimize the Kullback-Leibler divergence between an approximate distribution and the posterior of a deep Gaussian process. Most work on uncertainty focuses on Bayesian methods. However, Bayesian methods are generally computationally intensive and require significant modification to the training procedure. In contrast to Bayesian methods that involve soft model selection, Non-Bayesian approaches rely on model combinations. In other words, the models are combined to achieve better performance. A known non-Bayesian approach is deep ensembles. This method computes the quantification of uncertainty from the sampling of several models, where each model is trained separately on a subset of a dataset or the same dataset. They have been successfully used in ImageNet or Kaggle contests to boost performance.

Two LEA scenarios have been addressed by the framework. In the first scenario, suspects who are under investigation consent to grant LEAs access to their files, since they believe the illicit material is hidden and cannot be uncovered, i.e., the suspect's device may no longer be accessible due to encryption. The triage tools of LEAs that attempt to analyze the content are unable to detect them in encrypted devices. The model described herein could be incorporated into a triage tool to detect the file types of encrypted data, which would be a viable solution with regard to LEA investigative efforts. In the second scenario, law enforcement agents would like to run the file content detection tool on files seized from a crime scene investigation or at the frontline (e.g., at border crossings). Consider a scenario where Customs and Border Protection (CBP) that inspects travelers entering the United States suspects a traveler having a device with illegal material. However, the Fourth Amendment to the United States Constitution protects the traveler against unreasonable government searches and seizures. This generally means the government has to show a court probable cause that a crime has been committed and get a warrant before it can search a laptop or any device in which the traveler has a reasonable expectation of privacy. Without opening the file, the LEA can use the technique described herein to understand if the device consists of any encrypted or compressed data of a particular type, such as pictures or videos. In both scenarios, it is essential for the agents to identify the file types of the encrypted or compressed files without decrypting the files, to get a court order to unlock the device.

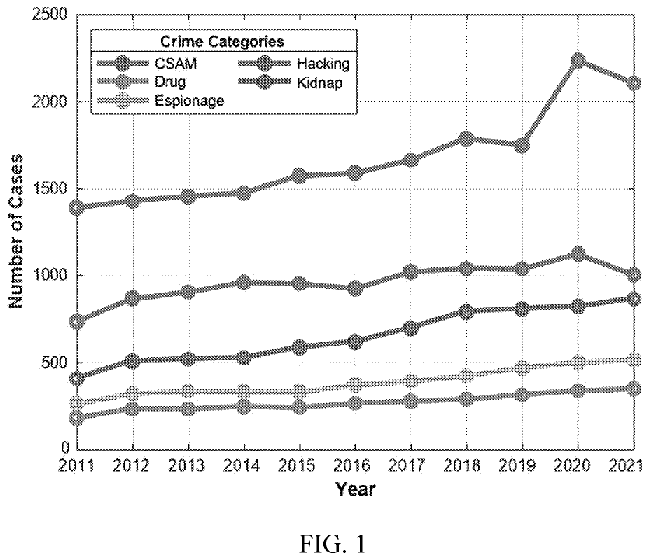

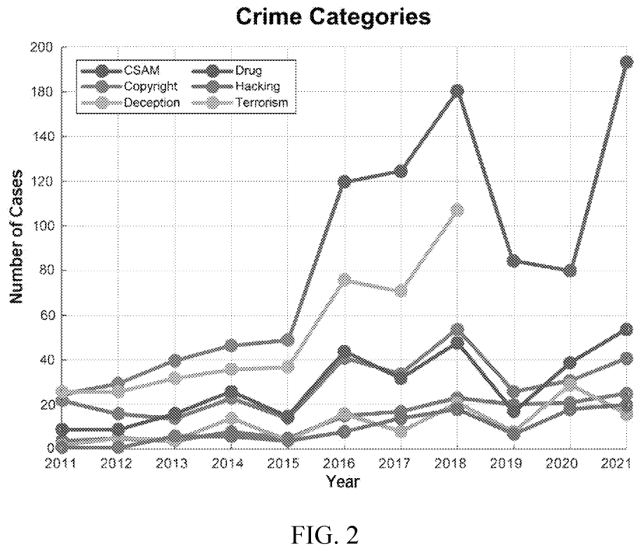

Data collected from two sources were used: (1) crime records collected from Federal Case data on LexisNexis and (2) discussions on EUR-Lex, which consists of both EU-law and case-law as well as National law and case-law spanning from 2011 to 2021, based on the search of the following list of keywords in this experiment: ‘Copyright encryption’, ‘Child pornography encryption’, ‘Deception encryption’, ‘Drug encryption’, ‘Espionage encryption’, ‘Embezzlement encryption’, ‘Hacking encryption’, ‘Abduct encryption’, ‘Homicide encryption’, ‘Terrorism encryption’, etc., in both sources. In Lexis-Nexis and EUR-Lex, the advanced search API was used to search for these keywords. In total, 210,584 crime records were collected from LexisNexis and 1,885 discussions from EUR-Lex. To better understand the temporal trends in encrypted file-related crime, a linear regression analysis was performed. The results of the experiment are depicted in FIGS. 1 and 2 and Tables 1 and 2. The analysis revealed a significant increase in the use of file encryption and encrypted files in criminal activities over the years. In the US, CSAM (child sexual abuse materials) cases were more frequent than other criminal activities, such as drug, espionage, hacking, kidnap, deception, and financial offense, in encrypted-related federal cases on LexisNexis. Criminal activities involving encryption and CSAM increased by 76.49 units every year in America. There is also a linear trend in encrypted crime activities in Europe, where terrorism cases were more frequent than other criminal activities such as CSAM, Copyright, Deception, Drug, and Hacking in the area of encryption. Specifically, the crime activities in the area of encryption on terrorism increase by 8.973 units every year in Europe.

TABLE 1
Linear modeling of LexisNexis data.

| Crime Categories | R² | β |
|---|---|---|
| CSAM | 0.8378 | 76.49*** |
| Copyright | 0.0978 | 12.46 |
| Deception | 0.1879 | 20.2 |
| Drug | 0.9443 | 14.39*** |
| Espionage | 0.9444 | 23.5*** |
| Financial Offense | 0.008 | −1.67 |
| Hacking | 0.9672 | 45.98*** |
| Kidnap | 0.7552 | 27.07*** |
| Terrorism | 0.122 | −8.17 |

Note.
* p < .05,
** p < .01,
***p < .001

TABLE 2
Linear modeling of EUR-Lex data.

| Crime Categories | R² | β |
|---|---|---|
| CSAM | 0.8831 | 2.3545*** |
| Copyright | 0.4096 | 2.4818* |
| Deception | 0.49 | 1.7818* |
| Drug | 0.5785 | 3.718** |
| Espionage | 0.311 | 1.2364 |
| Financial offense | 0.3133 | 0.6727 |
| Hacking | 0.7536 | 1.8182*** |
| Kidnap | 0.1971 | 0.6364 |
| Terrorism | 0.7746 | 8.973*** |

Note.
*p < .05,
**p < .01,
***p < .001

Therefore, to effectively address the need to combat the use of encryption in concealing illicit material there is an urgent need for an automatic detection technique of the file types so that law enforcement agents can further investigate such crimes. Such techniques can greatly facilitate investigations and help in the fight against cybercrime. By developing and implementing effective automatic detection techniques, LEAs can more efficiently identify and apprehend cybercriminals who use encryption to carry out illegal activities. In later sections, each calculated BFD is treated as an individual sample for clustering analysis based on Exploratory Factor Analysis (EFA) to unveil the presence of discernible patterns, and K-Means clustering is also employed for the purpose of designing labels for the subsequent ML algorithms.

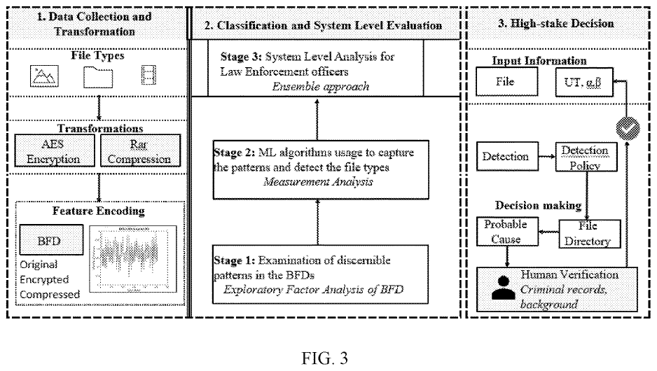

FIG. 3 is a block diagram of the innovative concept and framework, which includes three major components, namely: (1) Data Collection and Transformation, (2) Classification and System Level Evaluation, and (3) High-Stake Decision Making. The first component (“1. Data Collection and Transformation”) involves obtaining file types from various categories, subjecting them to transformations through encryption and compression, and generating the Byte Frequency Distribution (BFD) dataset. This dataset serves as the input for all subsequent ML algorithms. The second component (“2. Classification and System Level Evaluation”), drives the exploratory research by answering three research questions. First, to effectively use ML to detect the file types of encrypted or compressed files, a detection of discernible patterns in the data is required. This is addressed based on the following research question (RQ). RQ1: Are there discernible patterns in the BFDs that can characterize the file types? RQ2: Can ML algorithms capture those patterns and detect the file types? Lastly, the practical usage of such ML algorithms is developed into a system that can be used by LEAs in real-world scenarios. Such a system must also address the problem of uncertainty in ML algorithms which is critical in high-stake decision-making scenarios. This is addressed based on the following RQ. RQ3: How can ML algorithms be used in a system to detect the file types in encrypted or compressed files for law enforcement applications?

The third component (“3. High-stake Decision Making”), serves as an extension of the problem addressed in RQ3, showing the LEAs will have control over the detection policy. Our framework uses two tuning parameters, α, and β, and an uncertainty threshold (UT) to cater to diverse law enforcement applications. A directory is flagged if both a % images with at most UT uncertainty, and 0% encrypted files are detected in the inspected directory. A human-in-the-loop (HiTL) strategy is used to fine-tune these parameters according to the needs of an operator. A human feedback loop allows the human operator to take in intermediate predictions with consideration to the application context, such as a suspect's criminal background, leading to a more optimal α, β configuration.

For RQ1, due to the highly dimensional nature of the dataset, traditional data analysis methods may not yield meaningful patterns. Therefore, Exploratory Factor Analysis (EFA), a powerful statistical technique for dimensionality reduction and uncovering hidden structure, is used. EFA enables the reduction of data to a smaller set of essential variables (also known as factors), which can make data more manageable and easier to interpret. Also, EFA can reveal the hidden structure or patterns within the dataset that may not be apparent through simple inspection. Specifically, EFA allows us to discover the existence of discernible patterns and reliable factors that could then be used for learning via ML techniques.

Principal Component Analysis (PCA) was utilized as the extraction method in the EFA, followed by Varimax rotation with Kaiser Normalization to uncover the underlying structure of the measured items. The rotated component matrix yielded a number of factors, each associated with factor loadings indicating the strength of the relationship between the items and the extracted factors. Subsequently, certain items with low factor loadings were eliminated, and the remaining items were subjected to Cronbach's alpha reliability analysis to assess internal consistency, correlations, and the reliability of the items measuring the intended construct. The results, displayed in Table 3, illustrate Cronbach's alpha values ranging from 0 to 1, with higher values denoting increased internal consistency. Upon observing factors 4 and 5 from the text categories, despite their identification as unique factors, the relatively small Cronbach's Alpha value suggests that the scale may not be a reliable measure of the intended construct. This is indicative of poor inter-relatedness between items, leading to low internal consistency. The presence of reliable factors in the dataset addresses RQ1, where the reliable factors in the dataset represent the presence of discernible patterns in the data.

TABLE 3
Factor reliability (Cronbach's alpha).

| | Factor 1 | Factor 2 | Factor 3 | Factor 4 | Factor 5 |
|---|---|---|---|---|---|
| AVI | 1 | 0.98 | — | — | — |
| JPG | 0.999 | 0.93 | — | — | — |
| MP3 | 0.999 | 0.997 | 0.989 | — | — |
| PDF | 1 | 0.94 | — | — | — |
| TXT | 1 | 0.982 | 0.976 | 0.27 | 0.082 |

While EFA is applied to identify underlying factors, natural groups or clusters are simultaneously identified based on the similarity of samples in the dataset, which would enable labels to be set for a supervised learning paradigm. The dataset comprises five distinct data categories, with each category encompassing five states of the same file: original, compressed, encrypted, compressed then encrypted, and encrypted then compressed. Including the original non-encrypted file types serves as a baseline or reference point for the other states of the file. It allows for a direct comparison with the altered formats, aiding in the identification of any discrepancies or anomalies resulting from these transformations. In practical situations, having the original file type is essential as it mirrors real-world scenarios where forensic investigators or security analysts need to identify and recover the original content from various states. This well-structured alignment provides the necessary prerequisites for clustering analysis. Cluster analysis would not only reveal the clustering patterns in the dataset but also facilitate comprehensive insights into the correlation of the clusters with the distinct data categories. The method k-means clustering was used to analyze groupings in the dataset. The K-means results are displayed in Table 4. Notably, the distribution patterns of encrypted (enc), encrypted then compressed (enc_rar), and compressed then encrypted (rar_enc) files exhibit similarities among video (Cluster 3 & 4), image (Cluster 3 & 4), and audio categories (Cluster 5). However, when considering the additional compressed (rar) file type, distinct groups emerge for documents (Cluster 2 & 4) and text (Cluster 1, 4, & 5) categories. This observation influenced the decision to combine “enc”, “enc_rar”, and “rar_enc” into one label, treat “original” as a separate label, and assign a unique label to “rar” items. Such insights gleaned from the clustering analysis have proven valuable in refining the classification of data categories, leading to more effective and meaningful grouping. The primary objective of this study is to identify patterns of the data to indicate their file types based on BFDs, and not to unveil file-specific details in the encrypted cyphertext. Moreover, within the dataset, a substantial majority, specifically 3 out of 5 file formats, employ encryption as an added layer of data protection. This strategic choice further reinforces the safeguarding of information privacy, ensuring that there is no inadvertent information leakage across samples of identical files. Overall, the analyses brought forth clear discernible patterns in the BFD dataset as well as the way the data is clustered, which are important findings for designing ML algorithms to fit this type of data.

TABLE 4
Distribution of item among K-Means Clustering (K = 5). Different
color cells denote the grouping of items with similar patterns.

| | Cluster1 | Cluster2 | Cluster3 | Cluster4 | Cluster5 |
|---|---|---|---|---|---|
| AVI | | | | | |
| enc | 0 | 0 | 11302 | 698 | 0 |
| enc rar | 0 | 0 | 11302 | 698 | 0 |
| rar enc | 0 | 0 | 11125 | 875 | 0 |
| original | 2861 | 4064 | 0 | 0 | 5075 |
| rar | 0 | 0 | 469 | 11531 | 0 |
| JPG | | | | | |
| enc | 0 | 1 | 7199 | 4800 | 0 |
| enc rar | 0 | 3 | 7196 | 4801 | 0 |
| rar enc | 0 | 5 | 7163 | 4832 | 0 |
| original | 4521 | 5867 | 0 | 3 | 1609 |
| rar | 1120 | 4752 | 331 | 5795 | 2 |
| MP3 | | | | | |
| enc | 0 | 0 | 1 | 2 | 11997 |
| enc rar | 0 | 0 | 1 | 2 | 11997 |
| rar enc | 0 | 0 | 3 | 2 | 11995 |
| original | 109 | 3567 | 4597 | 3727 | 0 |
| rar | 4884 | 0 | 5 | 13 | 7098 |
| PDF | | | | | |
| enc | 31 | 9560 | 0 | 2409 | 0 |
| enc rar | 67 | 9527 | 0 | 2406 | 0 |
| rar enc | 96 | 9109 | 0 | 2795 | 0 |
| rar | 195 | 8286 | 0 | 3519 | 0 |
| original | 2171 | 3 | 9467 | 240 | 119 |
| TXT | | | | | |
| enc | 1820 | 58 | 0 | 3085 | 7037 |
| enc rar | 2082 | 314 | 0 | 2854 | 6950 |
| rar enc | 3333 | 132 | 0 | 4193 | 4343 |
| rar | 4727 | 357 | 0 | 4807 | 2109 |
| original | 0 | 11995 | 5 | 0 | 0 |

For RQ2, a large-scale measurement analysis on five distinct data categories, namely: Audio Video Interleave (AVI), Joint Photographic Experts Group (JPEG), Motion Pictures Expert Group Layer-3 (MP3), Portable Document Format (PDF), and Text (TXT), using 22 state-of-the-art ML architectures. For the evaluation, the data is organized into 15 classes—three variations for each of the five base types (AVI, JPEG, MP3, PDF, and TXT)—namely the original, encrypted using AES-CBC, and compressed with RAR. Referencing Table 5, the precision, recall, F1 score, and accuracy metrics were noted for a diverse range of ML architectures, utilizing 5-fold cross-validation for model training. This method partitions the data into five equal parts, where fthe parts are used for training and one part for validating, cycling through each part as the validation set, to ensure model robustness and reduce overfitting. While some models underperformed on the detection task, some models were able to achieve an F1 score greater than 75%. A particular model, the Ensemble Bagged Trees (EBT) demonstrated most effective performance compared to other techniques, achieving an F1 score of 78.40%. EBT is an ML algorithm that uses multiple decision trees, built from different subsets of the original data, to improve prediction accuracy and avoid overfitting. Each tree in the ensemble independently classifies new inputs, and the final classification is decided by a majority vote, making the combined model more robust than a single decision tree. This method is particularly effective for data with high variance, as it reduces variance without increasing bias, thus providing more reliable predictions. It is believed that EBT's superior performance is because ensembling directly addresses the randomness introduced by encryption and compression in the BFDs by learning several models that mitigate individual mispredictions by the collective decision-making process.

TABLE 5
Measurement analysis results.

| Model | Precision | Recall | F1-Score | Accuracy |
|---|---|---|---|---|
| EBT | 77.33 | 81.00 | 78.40 | 77.41 |
| Wide NN | 75.67 | 76.13 | 74.80 | 66.25 |
| SVM-Kernel | 75.27 | 77.93 | 75.40 | 68.08 |
| Fine Gaussian SVM | 74.93 | 74.40 | 76.20 | 73.27 |
| Medium NN | 74.75 | 75.07 | 73.67 | 65.38 |
| Logistic | 73.93 | 76.47 | 74.13 | 66.72 |
| Regression-Kernel | | | | |
| Narrow NN | 73.87 | 74.87 | 73.33 | 65.15 |
| Linear SVM | 73.40 | 74.53 | 72.87 | 63.67 |
| Bilayered NN | 73.20 | 74.07 | 72.27 | 64.68 |
| Coarse Gaussian | 72.80 | 75.27 | 72.33 | 64.90 |
| SVM | | | | |
| Subspace Disc | 70.87 | 68.67 | 67.67 | 55.68 |
| Ensemble | | | | |
| Trilayered NN | 69.73 | 70.93 | 68.60 | 62.59 |
| Fine KNN | 69.53 | 67.40 | 66.07 | 65.20 |
| Weighted KNN | 69.13 | 66.93 | 65.33 | 64.78 |
| Subspace KNN | 58.87 | 68.67 | 67.67 | 67.36 |
| Ensemble | | | | |
| Cubic KNN | 58.39 | 52.00 | 50.51 | 42.61 |
| Medium KNN | 57.45 | 51.87 | 49.49 | 41.64 |
| Cosine KNN | 56.73 | 50.53 | 51.56 | 39.20 |
| Coarse KNN | 55.93 | 51.67 | 47.42 | 40.62 |
| Boosted Trees | 52.07 | 51.21 | 46.43 | 50.59 |
| Ensemble | | | | |
| RUSBoosted Trees | 51.06 | 47.00 | 41.85 | 43.00 |
| Ensemble | | | | |
| Gaussian Naive | 44.59 | 37.71 | 38.35 | 42.90 |
| Bayes | | | | |

RQ3 inquires adapting these findings to the LEA application in which directory-level decisions are desirable. Because the LEA needs to procure a court order to unlock a suspicious device, a measure of uncertainty quantification is needed for this high-stake decision. Further, in order to support diverse operational environments, from airport scanning to law enforcement investigations, HiTL feedback to update the operational parameters is needed. Because the data used for training and evaluation should represent a spectrum (encrypted and nonencrypted) of real-world data types the LEA may and will most likely encounter during a deployment scenario, the file types and their transformations have been chosen in an attempt to create a more exhaustive model. With consideration that there is precedence for sex offenders to have limited or no access to the internet and a waiver of their 4th amendment rights, having a large corpus of images and videos is extremely alarming. With these considerations, the desired function of the tool is to flag file directories that warrant further inspection based on a determination of the file contents. The focus is therefore to detect whether a file directory contains a predefined fraction of encrypted images or video file types (i.e., the most critical file types used to store illegal material) with certainty. These file types are considered to contain illegal encrypted content and the other three categories are considered to contain safe content.

The construction of this system is in three parts. First, an ML algorithm trained to determine file types of interest is developed. For each file of interest, there are three states: Original BFD, Compressed BFD, and any BFD that has had a form of encryption applied to it (these states are chosen based on the k-means analysis discussed above). Second, data output from this model, commonly referred to as testing output, would then be assessed based on the trained model's uncertainty with respect to each piece of input data. This is accomplished by sampling an underlying distribution via the intermediate predictions of the ensemble model and measuring the entropy associated with the sampled data. Third, the system is capable of producing both a prediction and uncertainty (entropy) associated with each BFD of interest. These will be used to label a directory with consideration to an uncertainty threshold of the LEA's preference using algorithm 1. The latter encompasses both the ML component that predicts the individual file types and the formation of directories that consider uncertainty.

The perspective taken here is that files of high uncertainty should be discarded to prevent the overaccumulation of False Positives (FP). With the trained system being given a BFD for analysis and a level of uncertainty the LEA agrees to be acceptable; the system will predict whether the file type is original, compressed, or encrypted, and determine the uncertainty of that prediction. The uncertainty value will be determined if it is below the uncertainty threshold (UT). If it is, then if the file is determined to be of illegal content (IC) type such as movies and images, then the criteria 1 buffer (of length directory size) is incremented at the corresponding element. The same process is done on the predicted value for encrypted files thereby creating the criteria 2 buffer. Following the construction of the Criteria 1 and Criteria 2 buffers, which represent the original directories being predicted with a HiTL-determined level of acceptable uncertainty. Algorithm 2 is now used to determine if the inspected directory needs further investigation as defined by the percent of acceptable IC (α) or encrypted data (β). If either of those conditions are met, the system will flag the directory for further investigation. Else the system will not flag the directory for further investigation.

In high-stake decision-making applications, a method for quantifying the uncertainty in a model's prediction is vital. Traditional models often provide a confidence score, which, unfortunately, does not reflect the model's predictive uncertainty adequately. To address this, the framework employs Ensemble Bagged Tree (EBT) model, since this model was shown to be the best performing model in the measurement analysis above. EBT generates multiple individual predictions from all the models in the ensemble, forming an underlying distribution, from which the entropy is calculated to estimate predictive uncertainty. Notably, ensemble techniques are simple to implement and have been shown to outperform single models in predictive performance (precision, recall) while also allowing for uncertainty quantification. Inspired by deep ensemble techniques that exhibit approximate Bayesian behavior in deep learning models, the approach aims to create a model more robust to data that was not seen during its training phase.

The approach can be explained in the following steps. The EBT technique generates a series of individual predictions represented by p₁, p₂, . . . , pₙ. From this distribution, the entropy H as a measure of predictive uncertainty is calculated using the following formula:

$$H ( p ) = - \text{?} {p}_{i} {log}_{2} {p}_{i} \qquad ( 1 )$$

$$\text{?} \text{indicates text missing or illegible when filed}$$

In summary, the EBT technique generates multiple predictions for each input. These predictions are then used to assess the model's uncertainty about the input using entropy as a measure of uncertainty.

An instance of the framework/system was developed in Python, utilizing the Sci-Kit Learn library to construct an Ensemble Bagged Tree (EBT) Classifier. Based on the findings presented above, an EBT was selected because of its robust performance with stochastic data and its strong ability to handle uncertainty. The EBT model was assembled using a specific number of estimators for the ensemble model, which in testing was chosen to be 10. The EBT model generated a categorical distribution from the intermediate predictions of the ensemble, and a measure of uncertainty was developed for each data point by calculating the entropy of this distribution. For each data point, the model's predictions, obtained through polling, provided two metrics: confidence and uncertainty. After training and deploying the EBT model, the directory sizes was defined and assembled to evaluate the effectiveness of the method. Algorithms 1 and 2 were applied to assess the state of the directory, thereby determining if further investigation and resource allocation were necessary. IBM SPSS V25 was used for conducting the exploratory factors analysis and the measurement study was performed using the MATLAB Classification Learner application.

The overarching aim of the evaluation presented here is two-fold. The first objective is to provide an operational guide for using the system/method to detect illegal file types, by providing a guiding parameter that would help an LEA understand and interpret the results of the system on a directory-level, as well as tune it for best performance. A series of tests that exemplify the optimal selection of the α and β parameters were conducted. Furthermore, the influence of uncertainty on the system's performance was investigated, with an emphasis on precision and recall. We included nonencrypted files to ensure that results are not excluded during the evaluation and to create an environment most similar to that experienced by LEA during deployment scenarios. A more comprehensive range for the selection of α and β parameters (the ratio of encrypted and non-encrypted) can be determined. This includes low encrypted to high encrypted and low non-encrypted to high non-encrypted. Due to the inherently stochastic nature of encryption algorithms and the randomness introduced by them in BFDs, real-world applications must be able to not only perform well with traditional metrics, but also effectively characterize and convey uncertainty about its assessment. Introducing uncertainty will allow for the better allocation of resources for LEAs in high-impact decision-making and help manage errors. This paradigm is an intuitive choice when confronted with data ambiguity as a result of intentional concealment. The aim of this evaluation is to validate the effectiveness of the framework in flagging directories that could contain an image or video file type since these file types are some of the most common types concealed by suspects using encryption and compression. Here the classification as suspicious will imply the need for further investigation into the contents of the file. Additionally, the tuning parameters, α, β, and Uncertainty Threshold (UT) are provided to the LEA for leveraging prior knowledge to create filtering criteria and reduce false positives. The tuning parameters will allow for the agent to exercise more discretion in a scenario where the file was collected under circumstances that warrant suspicion or if the potential offender has a criminal history.

By implementing a HiTL strategy, the operational parameters are refined to meet the specific needs of diverse scenarios. In law enforcement applications where heightened sensitivity is crucial, parameters can be adjusted for minimal tolerance to errors. Conversely, in environments such as airports, where the focus is on identifying significant threats, a higher tolerance threshold can be set to reduce false positives. This adaptable HiTL methodology enables the tool to achieve an optimal balance between sensitivity and specificity, tailoring its performance to the unique requirements of each operational context.

In practical, real-world scenarios, the system would be run on directories of suspected files. Therefore, the model is encapsulated in the system with tunable parameters suitable to be applied to a file directory instead of individual files. Two criteria are established based on three parameters: α, β, and an Uncertainty Threshold (UT). These criteria are considered under the precondition that the data being evaluated satisfies the certainty requirement defined by the UT. Criteria 1 is fulfilled if the percentage of files in the directory being examined are images or videos is at least α. Criteria 2 is met if the percentage of files in the device container under test (DCUT) that are encrypted or compressed reaches β. If a DCUT satisfies both these criteria, it is flagged for further investigation by the agent. In order to assess the accuracy of the system's output, it is compared against the ground truth of the file. More specifically, the actual percentages of predicted files are verified to be at least as high as their corresponding tuning parameters, α and β. For instance, a flagged directory with at least α percent of images or video files and β percent of encrypted/compressed files would be considered a true positive. Using this evaluation strategy, values for α, β, UT, and directory sizes were explored to gain insights into the optimal tuning parameters for this particular problem.

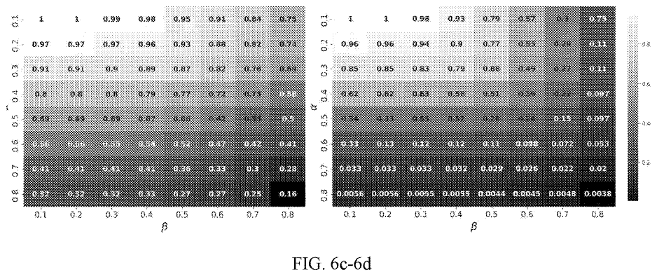

Operational uncertainty (UT) is defined relative to the entropy distribution associated with the data. In information theory, entropy refers to the randomness or disorder in a set of data. An analysis of entropy values computed during the classification process led to a determination that 0.7 was approximately nominal for the dataset, even after considering outliers. This value is recommended for this dataset, recognizing that entropy values associated with other datasets may vary significantly and that the relative importance of True Positives (TP) and False Positives (FP) may differ depending on the reader's use case. FIGS. 6a-d illustrate the effects of uncertainty on precision and recall. This analysis unveils distinct regions of operational effectiveness—a term used to describe the trade-off between precision and recall. A lower uncertainty threshold of 0.4 (as shown in FIGS. 6a and 6b) widens the range of precision but shrinks the region of effectiveness for recall. In contrast, increasing the uncertainty threshold to 1.0 (FIGS. 6c and 6d) diminishes the region of effectiveness for precision, while expanding it for recall.

Of note is that the data utilized a UT of 0.7 in subsequent evaluations, however, 0.4 and 1.0 are used here to demonstrate variance in the data. Additionally, this evaluation was conducted with a fixed directory size of 10, chosen due to its effective display of variation. However, these trends are not limited to this directory size but larger directories tend to exhibit a quicker decrease in performance relative to alpha and beta.

An experiment to discern the operational regions for alpha and beta was conducted. For this, UT was held at a constant at 0.7, as this was approximately the median of the entropy distribution for the data. The directory size was varied to evaluate if a lookup table for determining operational procedures could be established. Despite running several tests on directory sizes ranging from 10 to 1000 and establishing a pass/fail criterion of a minimum precision of 0.9 and a recall of 0.5, it was determined that the optimal alpha-beta combination was largely independent of directory size. This combination was determined to be alpha=0.2 and beta=0.3, as can be seen in FIG. 6.

The reasons behind the independence of the alpha-beta combination from directory sizes may be due to the inherent properties of the dataset or the classification process, an aspect that warrants further investigation. These findings provide important insights into the operational behavior of the proposed system architecture. While the implications and potential applications of these findings are expansive and potentially far-reaching, they should be viewed as initial insights, paving the way for further investigation and optimization of the system's performance.

In the study to evaluate uncertainty with ensembles, ensemble estimators were sampled to gauge the uncertainty associated with model predictions. This methodology enables law enforcement agencies to tailor decision thresholds to specified levels of uncertainty, thereby mitigating the risk of False Positives (FPs). By factoring in this uncertainty, decision-makers can isolate potential FPs, prompting further investigation or additional information gathering before a final decision is made.

The primary objective of the evaluation is to discern how integrating uncertainty into the system's decision-making process affects the rate of FPs. Tests were conducted across various Uncertainty Thresholds (UTs), maintaining a constant directory size and alpha and beta values of 10, 0.2, and 0.3, respectively. Directories were assessed in accordance with Algorithms 1 and 2. An FP was defined as a directory predicted to contain at least α percent of images and videos, and at least β percent of encrypted files, but failing to meet these criteria upon inspection.

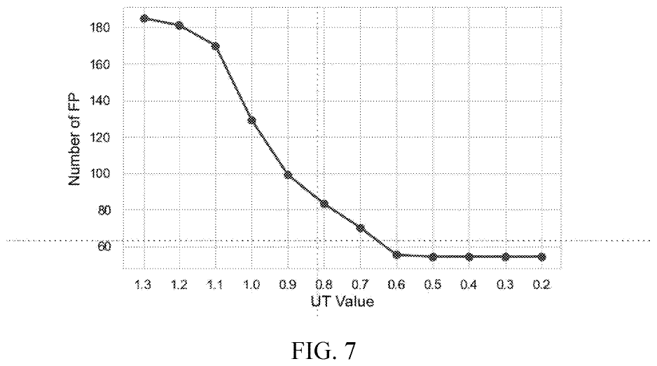

Throughout the evaluation, the occurrences of FPs were tracked at the directory level, documenting these trends in FIG. 7. The data suggest a clear trend towards a reduction in FP predictions as the required certainty level increases, corroborated by a lower UT. This outcome is intuitive: the more certainty the system requires for a data point, the less likely that data point is to be incorrectly classified as an FP.

In conclusion, the findings indicate that integrating uncertainty into the predictive process enhances system robustness and reduces FPs. This method fosters more prudent decision-making, potentially aiding law enforcement agencies in their pursuit of effective, evidence-based strategies. The framework is envisioned to be practically used in law enforcement applications, where the running time plays a crucial role in determining its adoption. In this experiment, the primary objective was to analyze the time complexity of the framework and evaluate the running time under practical scenarios.

For the evaluation of running time, the prediction time of the ensemble bagged tree model was measured, assuming that the model is already trained and ready for deployment by Law Enforcement Agencies (LEAs). Through empirical assessment, experiments were conducted using different numbers of estimator samples and recorded the corresponding running times for each execution of the framework. The number of estimators refers to the number of individual decision tree models used to create the ensemble, increasing the number of estimators can generally lead to improved performance up to a certain point, but it also increases the computational cost. The summarized results of these experiments are presented in Table 6, where the number of estimators varied from 10 to 1,000 and a proportional increase was observed in the running time. The time complexity analysis revealed that the runtime of the present system demonstrates a linear relationship with the number of estimators sampled.

TABLE 6
Elapsed time of eDefender with increasing
estimators of Ensemble Bagged Tree.

| Number of Estimators | Elapsed Time (Seconds) |
|---|---|
| 10 | 0.03 |
| 100 | 0.3 |
| 1,000 | 3.13 |

It is essential to acknowledge that this analysis is based on the current system implementation and the available data. Further investigation may be required to precisely determine the time complexity of the prediction component. Additionally, other factors, such as the specific implementation details, size of the input dataset, and hardware configurations, may also influence the overall time complexity of the system. These are factors to consider to optimize the running time for real-world law enforcement applications.

There is a crucial need for employing ML techniques in detecting the file types of encrypted files to prevent CSAM. This need is compounded by the recent innovation in Generative AI, where an input image can be transformed into a generated image that is manipulated using prompts. Generative AI has opened the floodgates for malicious actors in creating and sharing AI-generated CSAM. This type of content has already been made illegal in many parts of Europe, and there is an ongoing discussion of the US following suite. The system is a powerful method to combat the transfer of such content under encryption since the present system is automated. Although the system has been described for LEA applications, this invention is not so limited and its use may be expanded to other areas such as scanning media content on social media platforms.

Although the description herein focuses on commonly used encryption and compression techniques in cases investigated by partner LEAs such as AES and WinRar for encryption and compression respectively, the present system and method are applicable to other encryption and compression techniques. Second, the present system and method may use other ML techniques beyond those specifically identified herein.

One of the most important cautionary notes in using any ML technique is the utilization of the right dataset in the study. This becomes challenging in research that uses encrypted illegal materials such as CSAM. In this study, file types AVI, JPEG, MP3, PDF, and TXT were used instead of CSAM to evaluate the performance of the model. To enable further replication, the dataset will be made publicly accessible via the GitHub repository. Recent research has shown that people were willing to accept client-side scanning (CSS) measures to combat serious crimes such as child abuse or terrorism. Since the present system does not scan the content of the directories, but only inputs the BFDs, it is not possible to scan devices for private content. Incorporating a Human-in-the-loop (HitL) step as an integral component, the present system is designed to augment the capabilities of LEAs responsibly. The HitL approach ensures that the determination of a suspect's possession of illegal material is not solely reliant on an automated process, thereby reducing the risk of biases and false positives. It is imperative to stress that the present system is not fully autonomous; its deployment is contingent upon the oversight and judgment of trained professionals. By establishing a flexible framework that can be used in diverse operating environments, the present system aims to enhance the efficiency of LEAs while steadfastly respecting ethical boundaries.

The U.S. Customs and Border Protection (CBP) officers have a complex mission with law enforcement officers to search all travelers that enter the country. Keeping the mission in mind, travelers are subject to electronic searches such as laptop and cellphone searches. However, there have been concerns about the traveler's potential violation of First and Fourth Amendment rights on warrantless searches by the academia and the media. For example, in the Riley vs California case, through a unanimous decision, the U.S Supreme Court ruled that “police generally require a warrant in order to search cell phones, even when it occurs during an otherwise lawful arrest” (Electronic Privacy Information Center, n/d). The Riley v. California case and many other cases that have gone unreported reinforce the urgent need to design technical solutions to detect, analyze, and triage encrypted files.

Once a positive indication has been established, the LEA officers can either apply for a court order to unlock the device or conduct an in-depth forensic analysis. Currently, LEAs use several triage tools such as OSTriage, Kroll's Artifact Parser and Extractor (KAPE), Cellebrite Digital Collector, and ADF Triage Investigator. While these conventional tools can be helpful in uncovering evidence of interest during investigations, they are not designed to determine encrypted or compressed file types stored in file directories. The present approach can be used as a triage tool for detecting certain suspect file types in encrypted and compressed directories, and will serve as an important addition to the existing suite of triage tools. The present system can be deployed as an executable tool that can be conveniently and automatically run when it is connected to a suspect's device and provide a quick report about the flagged directories to the LEA during investigation.

Discussions with LEAs reveal the importance of time as a factor in the detection of illicit material in a directory. Since a suspect is confident that encryption will hide illicit content, they are quite likely to give consent to an on-the-spot search of their device. However, a crucial factor is the time taken to scan the suspect's device, since the suspect can legally revoke consent at any time during the investigation. A time complexity analysis of the framework found that the running time depends on the models sampled in the EBT component. However, in practice, many more parameters would come into play. For example, the techniques needed to interface with the suspect's device, scanning the content, and reporting the results in an effective manner. A rigorous implementation on specialized hardware may be needed to quickly scan and flag suspicions in real-world scenarios.

A physical embodiment of a tool that LEAs may use for file content detection may include a portable/mobile device with a data port such as USB, mini USB, or other types that may be used (with or without a cable) to access the files stored on a data storage device, such as USB flash drives, external hard drives (HDDs) and solid-state drives (SSDs). The tool may further have interface ports for interfacing with various readers or device configured to read devices such as memory cards (such as SD cards and microSD cards), and optical discs (CDs, DVDs, and Blu-ray discs), and the like. The tool may include a processor, memory, data port interface, an RF transceiver (for wireless communications), a network adapter, a display, and a user interface (e.g., touch screen, keyboard).

The features of the present invention which are believed to be novel are set forth below with particularity in the appended claims. However, modifications, variations, and changes to the exemplary embodiments of the file content detection system and method described above will be apparent to those skilled in the art, and the described herein thus encompasses such modifications, variations, and changes and are not limited to the specific embodiments described herein.

What is claimed is:

1. A method for identifying file content of a plurality of files in a file directory stored on a data storage device without decrypting or decompressing the files, the method comprising:
obtaining access to the files stored in the file directory on the data storage device;
determining a byte frequency distribution (BFD) for each file in the directory;
examining the BFD of each file using a machine learning model to predict a file type and an associated uncertainty value; and
flagging the file directory for further investigation when a predetermined percentage of the files contain targeted file content with uncertainty at or below a threshold and a predetermined percentage of the files are encrypted or compressed files.

2. The method of claim 1, wherein the machine learning model comprises an ensemble bagged tree (EBT) model.

3. The method of claim 2, wherein the uncertainty value is determined by calculating entropy from a distribution of predictions generated by a plurality of trees in the ensemble.

4. The method of claim 1, further comprising setting parameter values for α (percentage of targeted file content), β (percentage of encrypted or compressed files), and an uncertainty threshold (UT), wherein the flagging occurs when at least α % of the files contain targeted file content with uncertainty at most UT and at least β % of the files are encrypted or compressed.

5. The method of claim 4, wherein the targeted file content comprises image or video file types.

6. The method of claim 4, wherein α is approximately 0.2 and β is approximately 0.3.

7. The method of claim 1, further comprising evaluating additional data associated with the flagged file directory and revising at least one of the parameter values α, β, or UT based on the additional data.

8. The method of claim 7, wherein the evaluating comprises receiving human-in-the-loop (HiTL) feedback.

9. The method of claim 8, wherein the human-in-the-loop feedback includes evaluation of criminal records or background of a suspect associated with the data storage device.

10. A system for identifying file content of a plurality of files in a file directory stored on a data storage device without decrypting or decompressing the files, the system comprising:
an access port configured to communicate with the data storage device and obtain the files in the file directory;
a processor and memory storing instructions that, when executed, cause the processor to:
determine a byte frequency distribution (BFD) for each file;
examine the BFD of each file using a machine learning model to predict a file type and an associated uncertainty value; and
flag the file directory for further investigation when a predetermined percentage of the files contain targeted file content with uncertainty at or below a threshold and a predetermined percentage of the files are encrypted or compressed files; and
an output device configured to present information associated with the flagged file directory.

11. The system of claim 10, wherein the machine learning model comprises an ensemble bagged tree (EBT) model.

12. The system of claim 11, wherein the uncertainty value is determined by calculating entropy from a distribution of predictions generated by a plurality of trees in the ensemble.

13. The system of claim 10, wherein the instructions further cause the processor to set and apply parameter values for α (percentage of targeted file content), β (percentage of encrypted or compressed files), and an uncertainty threshold (UT) as recited in the flagging step.

14. The system of claim 13, wherein the targeted file content comprises image or video file types.

15. The system of claim 13, wherein α is approximately 0.2 and β is approximately 0.3.

16. The system of claim 10, wherein the instructions further cause the processor to evaluate additional data associated with the flagged file directory and revise at least one of the parameter values α, β, or UT based on the additional data.

17. The system of claim 16, wherein the evaluating comprises receiving human-in-the-loop (HiTL) feedback, including evaluation of criminal records or background of a suspect associated with the data storage device.

18. A non-transitory computer-readable medium storing instructions that, when executed by one or more processors, cause the one or more processors to perform the method of any one of claims 1 through 9.

19. The non-transitory computer-readable medium of claim 18, wherein the instructions further cause the one or more processors to implement the system of any one of claims 10 through 17 when the medium is executed in conjunction with the access port and output device of claim 10.

20. The non-transitory computer-readable medium of claim 18, wherein the machine learning model comprises an ensemble bagged tree (EBT) model and the uncertainty value is determined by calculating entropy from ensemble predictions.
